(19) United States
(12) Patent Application Publication
(10) Pub. No.: US 2025/0214185 A1
(43) Pub. Date: Jul. 3, 2025

(54) INSERT NUT FIXING DEVICE

(71) Applicant: HanJungNCS.CO., LTD, Yeongcheon-si (KR)

(72) Inventors: Goang Sik MIN, Yeongcheon-si (KR); Jae Soo KIM, Gyeongsan-si (KR); Jae Gu CHOI, Gyeongju-si (KR); Sung Pil HEO, Daegu (KR); Sung Wook JUNG, Gyeongsan-si (KR)

(73) Assignee: HanJungNCS.CO., LTD, Yeongcheon-si (KR)

(21) Appl. No.: 18/941,117

(22) Filed: Nov. 8, 2024

(30) Foreign Application Priority Data
Dec. 27, 2023 (KR) 10-2023-0192115

(51) Int. Cl. B23P 19/06; B23P 19/12

(52) U.S. Cl. CPC B23P 19/06; B23P 19/12

(57) ABSTRACT

Proposed is an insert nut fixing device including a body with a rod shape formed by extending in a longitudinal direction thereof and having an insertion groove formed on a longitudinal edge thereof, and an elastic movement means coupled to the insertion groove to be movable elastically in a vertical direction. The elastic movement means includes a holding jaw forming member formed by protruding on an upper side thereof.

### CROSS REFERENCE TO RELATED APPLICATION

The present application claims priority to Korean Patent Application No. 10-2023-0192115, filed Dec. 27, 2023, the entire contents of which are incorporated herein for all purposes by this reference.

### BACKGROUND OF THE INVENTION

### Field of the Invention

The present disclosure relates to an insert nut fixing device that enables a robot to hold and fix an insert nut.

### Description of the Related Art

A plate P supporting a battery cell has an insertion hole H perforated on a side thereof to insert an insert nut I thereto as illustrated in FIG. 1, and thus the insert nut I is inserted and fixed into the insertion hole H by using a robot.

In this case, the robot fixes the insert nut I by magnetizing the insert nut I to prevent the insert nut I from falling out during movement and an insertion process. However, there is a problem that the rigidity of the insert nut is reduced when the insert nut is made of a magnetizable material.

Therefore, there is an emerging need to develop a technology that is capable of fixing the insert nut in a way other than magnetization.

### DOCUMENTS OF RELATED ART

(Patent Document 1) Korean Patent No. 10-0808058 (Title: ARRAY INSERTION APPARATUS FOR INSERT NUT ON WIRE, registered on Feb. 21, 2008)
(Patent Document 2) Korean Patent No. 10-0832246 (Title: SUPPLY APPARATUS FOR INSERT NUT IN CASE OF MOBILE PHONE, registered on May 20, 2008)

### SUMMARY OF THE INVENTION

Accordingly, the present disclosure has been made keeping in mind the above problems occurring in the related art, and the present disclosure is intended to propose an insert nut fixing device capable of stably fixing an insert nut without magnetizing the insert nut.

In order to achieve the objective of the present disclosure, there is provided an insert nut fixing device including: a body 100 with a rod shape formed by extending in a longitudinal direction thereof and having an insertion groove 101 formed on a longitudinal edge thereof; and an elastic movement means 200 coupled to the insertion groove 101 to be movable elastically in a vertical direction.

In addition, the elastic movement means 200 may include a holding jaw forming member 210 formed by protruding on an upper side thereof.

In addition, the insertion groove 101 may include: a first insertion groove 101-1 located on a front side of the body 100, and a second insertion groove 101-2 located behind the first insertion groove 101-1, wherein a depth of a second insertion groove 101-2 may be larger than a depth of the first insertion groove 101-1.

In addition, the elastic movement means 200 may include: a front elastic movement means 200A arranged by being spaced apart from a surface of the body 100 having the first insertion groove 101-1; and a rear elastic movement means 200B located behind the front elastic movement means 200A and coupled to a surface of the body 100 having the second insertion groove 101-2.

In addition, the rear elastic movement means 200B may be welded to the body 100.

In addition, the body 100 may include a step portion 102 formed on a front edge thereof.

In addition, the elastic movement means 200 may include: a ball 220 fitted into the insertion groove 101; and an elastic member 230 configured to connect a lower side of the ball 220 and a surface of the insertion groove 101 to each other.

In addition, the body 100 may include an anti-separation rib 103 formed on a front side of the insertion groove 101.

In addition, the holding jaw forming member 210 may include a first member having a hemispherical shape located on an upper side thereof and made of a metal material; and a second member, which is made of rubber or silicone, coupled to a lower flat surface of the first member and connecting the first member and the elastic movement means 200 to each other.

In the insert nut fixing device of the present disclosure, the elastic movement means is inserted into a hole perforated in the center of an insert nut, and the holding jaw forming member is fitted between threads formed on the inner surface of the insert nut so that the insert nut is fixed, thereby enabling the insert nut to be stably fixed without magnetizing the insert nut.

In addition, the step portion is formed on the front side of the body, thereby allowing the insert nut to be constantly fixed in the same position.

Additionally, the anti-separation rib is formed on the front side of the insertion groove, and thus when a robot pulls the insert nut fixing device, the elastic movement means is pulled, and a force is concentrated on a coupling portion of the elastic movement means with the body, thereby preventing the coupling of the body and the elastic movement means from being released.

That is, the anti-separation rib is located in a direction in which the elastic movement means is pulled, thereby limiting the elastic movement means from being pulled with a force exceeding a certain level.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates a perspective view and a partially enlarged view of an insert nut being inserted into a groove formed on the edge of a plate according to the present disclosure;

FIG. 2 illustrates a perspective view and a partially enlarged view of an insert nut fixing device a first embodiment of the present disclosure;

FIG. 3 illustrates a cross-sectional view of the insert nut fixing device according to the first embodiment of the present disclosure;

FIG. 4 illustrates a perspective view and a partially enlarged view of an insert nut fixing device according to a second embodiment of the present disclosure; and

FIG. 5 illustrates a cross-sectional view of the insert nut fixing device according to the second embodiment of the present disclosure.

### DETAILED DESCRIPTION OF THE INVENTION

Advantages and features of embodiments of the present disclosure and methods for achieving them will become apparent with reference to the embodiments described below in detail together with the accompanying drawings. However, the present disclosure is not limited to the embodiments disclosed below and may be implemented in various different forms. The embodiments are provided only to ensure that the disclosure of the present disclosure is complete and to fully inform those skilled in the art to which the present disclosure belongs of the scope of the present disclosure, and the present disclosure is defined only by the scope of the claims. Throughout the specification, identical reference numerals refer to identical components.

In describing the embodiments of the present disclosure, when it is determined that a detailed description of a known function or configuration may unnecessarily obscure the gist of the present disclosure, the detailed description will be omitted. In addition, terms described below are terms defined in consideration of functions thereof in the embodiments of the present disclosure, and may vary depending on the intention or custom of a user or operator. Therefore, the definitions should be based on contents throughout this specification.

Hereinafter, an insert nut fixing device 1000 according to the present disclosure will be described with reference to the accompanying drawings.

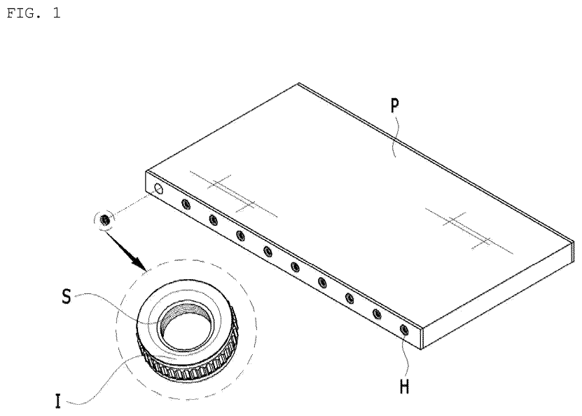

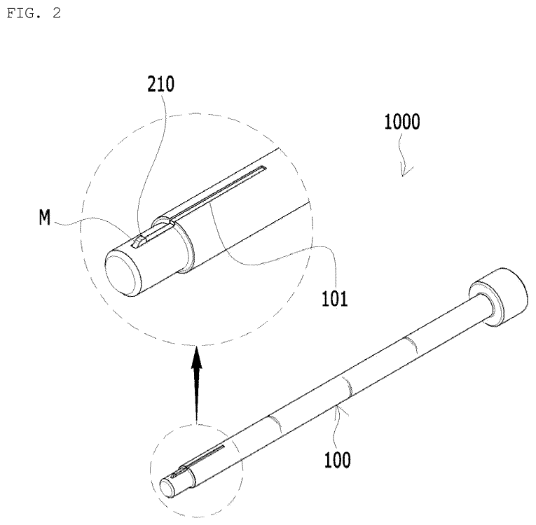

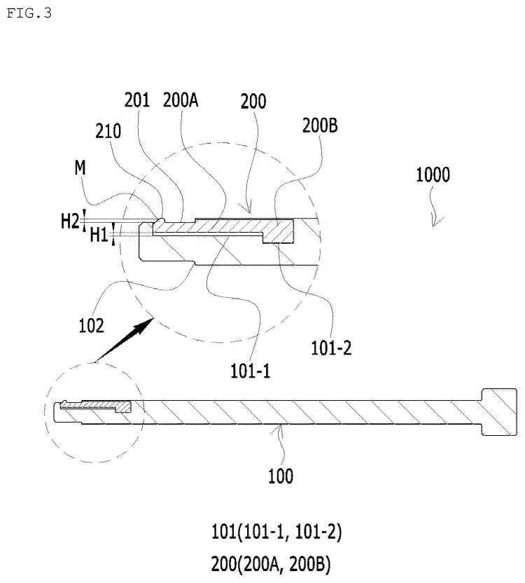

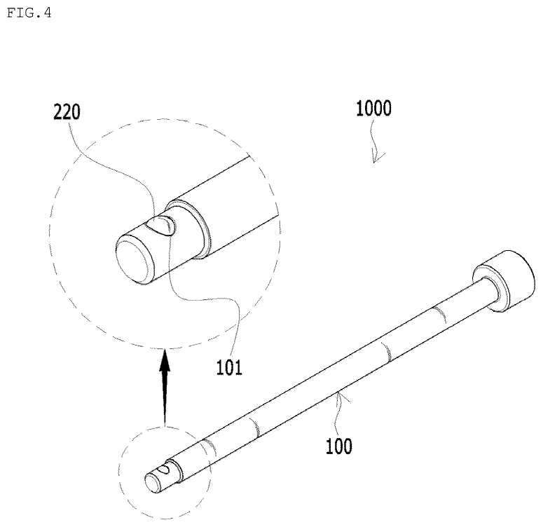

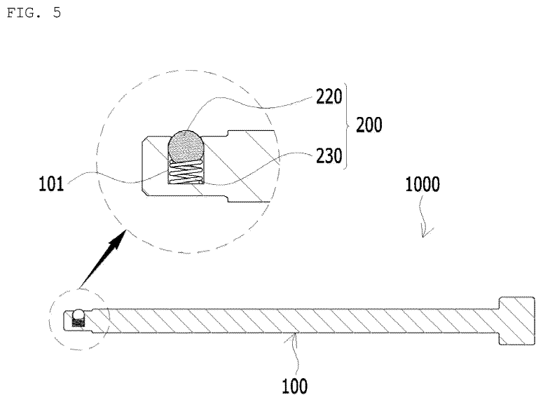

FIG. 1 illustrates a perspective view and a partially enlarged view of an insert nut being inserted into a groove formed on the edge of a plate according to the present disclosure; FIG. 2 illustrates a perspective view and a partially enlarged view of an insert nut fixing device a first embodiment of the present disclosure; FIG. 3 illustrates a cross-sectional view of the insert nut fixing device according to the first embodiment of the present disclosure; FIG. 4 illustrates a perspective view and a partially enlarged view of an insert nut fixing device according to a second embodiment of the present disclosure; and FIG. 5 illustrates a cross-sectional view of the insert nut fixing device according to the second embodiment of the present disclosure.

Referring to FIGS. 2 and 3, the insert nut fixing device 1000 according to the first embodiment includes a body 100 with a rod shape formed by extending in a longitudinal direction thereof and having an insertion groove 101 formed on a longitudinal edge thereof, and an elastic movement means 200 coupled to the insertion groove 101 to be movable elastically in a vertical direction, wherein the elastic movement means 200 may include a holding jaw forming member 210 formed by protruding on an upper side thereof.

To explain in detail, when a longitudinal side of the body 100 is coupled to a robot, and the robot inserts the body 100 into a hole perforated in the center of an insert nut I, the holding jaw forming member 210 is moved into the insertion groove 101 while the elastic movement means 200 is moved downward. When the insertion of the body 100 is completed, the elastic movement means 200 that is moved downward is restored to an original position thereof, and the holding jaw forming member 210 is fitted into a groove formed by threads S formed on an inner surface of the insert nut I, so that the insert nut I is fixed to the insert nut fixing device 1000.

In addition, the insertion groove 101 may include a first insertion groove 101-1 located on a front side of the body 100 and a second insertion groove 101-2 located behind the first insertion groove 101-1, and the elastic movement means 200 may include a front elastic movement means 200A arranged by being spaced apart from a surface of the body 100 having the first insertion groove 101-1, and a rear elastic movement means 200B located behind the front elastic movement means 200A and welded to a surface of the body 100 having the second insertion groove 101-2.

To explain in detail, when the body 100 is inserted into the hole perforated in the center of the insert nut I, the holding jaw forming member 210 is in contact with the side surface of the insert nut I and the elastic movement means 200 is moved downward. The elastic movement means 200, which is moved downward, is moved upward again when the body 100 is completely inserted into the center of the insert nut I, and the holding jaw forming member 210 is fitted into the groove formed between the threads of the insert nut I.

In this case, it is recommended that the holding jaw forming member 210 has an inclined surface M formed on one side in a longitudinal direction thereof so that the elastic movement means 200 is moved downward by a force transmitted when the holding jaw forming member 210 is in contact with the insert nut I.

Additionally, it is recommended that the depth H1 of a gap formed between the front elastic movement means 200A and the first insertion groove 101-1 is equal to the height H2 of the holding jaw forming member 210.

In addition, it is recommended that the depth of the second insertion groove 101-2 is larger than the depth of the first insertion groove 101-1, and thus when the rear elastic movement means 200B, which is formed to protrude downward, is inserted into the second insertion groove 101-2, a contact area between the surface of the second insertion groove 101-2 and the rear elastic movement means 200B increases so that welding between the second insertion groove 101-2 and the rear elastic movement means 200B can be stably performed.

That is, the contact area is maximized by forming a step structure through depth difference.

In addition, it is recommended that the body 100 has a step portion 102 formed on the front edge thereof, and when the body 100 is inserted into and fixed to the hole perforated in the center of the insert nut I, the depth of the body 100 inserted into the insert nut I is always maintained constant.

To explain in detail, the insert nut I is always coupled in a constant form to the insert nut fixing device 1000 of the present disclosure, so that a subsequent insert nut insertion process performed by a robot can be performed stably.

In this case, a step groove 201 corresponding to the step portion 102 may be formed on the elastic movement means 200.

In addition, although not shown in the drawing, the holding jaw forming member 210 includes a first member having a hemispherical shape located on the upper side thereof and made of a metal material, and a second member, which is made of rubber or silicone, coupled to the lower flat surface of the first member and connecting the first member and the elastic movement means 200 to each other. Accordingly, when the robot pulls the insert nut fixing device hard, the second member may be compressed, allowing the first member to be more easily removed from the insert nut.

Referring to FIGS. 4 and 5, in the insert nut fixing device 1000 according to the second embodiment, the elastic movement means 200 may include a ball 220 which is fitted into the insertion groove 101, and an elastic member 230 which connects the lower side of the ball 220 and the surface of the insertion groove 101 to each other.

To explain in detail, when the body 100 is inserted into the hole perforated in the center of the insert nut I, the elastic member 230 is compressed and the ball 220 moves downward, and when the insertion is completed, the elastic member 230 is restored and the ball 220 moves upward so that the ball 220 can be fitted into a groove formed between the threads of the insert nut I.

In this case, the elastic member 230 may include various members having high elastic restoring force, and may be a spring in an embodiment, but is not limited thereto.

The present disclosure is not limited to the above-described embodiments, and is broad in the scope of application. Those skilled in the art may make various modifications without departing from the gist of the present disclosure claimed in the claims.

What is claimed is:

1. An insert nut fixing device comprising:
a body (100) with a rod shape formed by extending in a longitudinal direction thereof and having an insertion groove (101) formed on a longitudinal edge thereof; and
an elastic movement means (200) coupled to the insertion groove (101) to be movable elastically in a vertical direction.

2. The insert nut fixing device of claim 1, wherein the elastic movement means (200) includes a holding jaw forming member (210) formed by protruding on an upper side thereof.

3. The insert nut fixing device of claim 2, wherein the insertion groove (101) includes:
a first insertion groove (101-1) located on a front side of the body (100), and
a second insertion groove (101-2) located behind the first insertion groove (101-1),
wherein a depth of a second insertion groove (101-2) is larger than a depth of the first insertion groove (101-1).

4. The insert nut fixing device of claim 3, wherein the elastic movement means (200) includes:
a front elastic movement means (200A) arranged by being spaced apart from a surface of the body (100) having the first insertion groove (101-1); and
a rear elastic movement means (200B) located behind the front elastic movement means (200A) and coupled to a surface of the body (100) having the second insertion groove (101-2).

5. The insert nut fixing device of claim 4, wherein the rear elastic movement means (200B) is welded to the body (100).

6. The insert nut fixing device of claim 3, wherein the body (100) includes a step portion (102) formed on a front edge thereof.

7. The insert nut fixing device of claim 1, wherein the elastic movement means (200) includes:
a ball (220) fitted into the insertion groove (101); and
an elastic member (230) configured to connect a lower side of the ball (220) and a surface of the insertion groove (101) to each other.
